(19) United States
(12) Patent Application Publication
(10) Pub. No.: US 2016/0301186 A1
(43) Pub. Date: Oct. 13, 2016

(54) QUASI-CONTINUOUS BURST-MODE LASER

(71) Applicants: Spectral Energies, LLC, (US); Iowa State University Research Foundation, Inc., (US); The Government of the United States, as Represented by the Secretary of the Air Force, Washington, DC, (US)

(72) Inventors: Sukesh Roy, Beavercreek, OH (US); James R. Gord, Beavercreek, OH (US); Terrence R. Meyer, Ames, IA (US); Mikhail N. Slipchenko, West Lafayette, IN (US)

(73) Assignees: SPECTRAL ENERGIES, LLC, Dayton, OH (US); The Government of the United States, as Represented by the Secretary of the Air Force, Was, Wright-Patterson AFB, OH (US); IOWA STATE UNIVERSITY RESEARCH FOUNDATION, INC., Ames, IA (US)

(21) Appl. No.: 13/767,937

(22) Filed: Feb. 15, 2013

Related U.S. Application Data
(60) Provisional application No. 61/755,558, filed on Jan. 23, 2013.

(51) Int. Cl. H01S 3/23; H01S 3/094; H01S 3/0941

(52) U.S. Cl. CPC H01S 3/2316; H01S 3/0941; H01S 3/094042; H01S 3/094076

(57) ABSTRACT

A high-energy, high-power, burst-mode laser is disclosed. The laser comprises a master oscillator, which generates a signal. The signal may be a continuous signal or a pulsed signal. The master oscillator optically couples to a pulse picker that creates a train of pulses from the signal, and the spacing between the pulses of the train of pulses ranges from ten nanoseconds to one millisecond. The pulse picker is optically coupled to a first diode-pumped amplifier that amplifies the train of pulses to create a first amplified pulse train.

### CROSS REFERENCE TO RELATED APPLICATIONS

This application claims the benefit of U.S. Provisional Patent Application Ser. No. 61/755,558, filed Jan. 23, 2013, the disclosure of which is hereby incorporated by reference in its entirety.

### STATEMENT REGARDING FEDERALLY SPONSORED RESEARCH OR DEVELOPMENT

This invention was made with government support under Contract No. FA8650-10-C-2008 awarded by U.S. Air Force. The Government has certain rights in this invention.

### BACKGROUND

Various aspects of the present disclosure relate generally to burst-mode lasers and specifically to high-energy, high-power, burst-mode lasers.

Burst-mode lasers are used in various applications including high-speed measurements of temperature, mixture fraction, planar laser-induced fluorescence (PLIF) of OH, NO, CH, and CH₂O, and Raman line imaging of O₂, N₂, CH₄, and H₂. These burst-mode lasers typically burst about ten to one hundred pulses for about one millisecond with per-pulse energy on the order of 100 millijoules per pulse and pulse widths on the order of nanoseconds.

### BRIEF SUMMARY

According to aspects of the present disclosure, a high-energy, high-power, burst-mode laser is disclosed. The laser comprises a master oscillator, which generates a signal. The signal may be a continuous signal or a pulsed signal. The master oscillator optically couples to a pulse picker that creates a train of pulses from the signal. The spacing between the pulses of the train of pulses ranges from ten nanoseconds to one millisecond. The pulse picker is optically coupled to a first diode-pumped amplifier that amplifies the train of pulses to create a first amplified pulse train.

According to further aspects of the present disclosure, an all-diode, high-energy, high-power, quasi continuous burst-mode laser is disclosed. The laser comprises a fiber laser, which generates a signal, and is optically coupled to an electro-optical modulator (EOM). Further, the EOM is configured in a double-pass configuration such that the signal passes through the electro-optic modulator in a first direction, contacts a reflector perpendicular to the signal, and passes through the electro-optic modulator again in the direction opposite of the first direction. The EOM receives the signal and creates a train of pulses from the signal, where the spacing between the pulses of the train of pulses is 10 microseconds or more.

The EOM optically couples to a first spatial filter, which optically couples to a first diode-pumped amplifier including a neodymium-doped yttrium aluminum garnet rod that is 2 millimeters in diameter, and the first diode-pumped amplifier amplifies the train of pulses to create a first amplified pulse train. The first diode-pumped amplifier optically couples to a quartz rotator that optically couples to a second spatial filter.

The second spatial filter optically couples to a second diode-pumped amplifier including a neodymium-doped yttrium aluminum garnet rod that is 2 millimeters in diameter, and the second diode-pumped amplifier amplifies the first amplified pulse train to create a second amplified pulse train. Further, the second diode-pumped amplifier optically couples to a third spatial filter, which optically couples to an optical isolator, which optically couples to a third diode-pumped amplifier.

The third diode-pumped amplifier includes a neodymium-doped yttrium aluminum garnet rod that is 5 millimeters in diameter and is configured in a double-pass configuration such that the second amplified pulse train passes through the electro-optic modulator in a first direction, passes through a vacuum cell, contacts a reflector perpendicular to the second amplified pulse train, passes through the vacuum cell again in the direction opposite of the first direction, and passes through the electro-optic modulator again in the direction opposite of the first direction. Further, the third diode-pumped amplifier amplifies the second amplified pulse train to create a third amplified pulse train.

According to still further aspects of the present disclosure, a method for creating a high-energy, high-power burst of pulses is disclosed. The method comprises creating a train of pulses including pulses with a pulse width greater than one nanosecond and a spacing between the pulses of the train of pulses ranging from ten nanoseconds to one millisecond. That train of pulses is amplified using a diode-pumped amplifier. A burst of pulses, based on the train of pulses, is emitted, and the pulses in the burst of pulses include an average of at least 100 millijoules per pulse.

### BRIEF DESCRIPTION OF THE SEVERAL VIEWS OF THE DRAWINGS

FIG. 1 is a block diagram illustrating a quasi-continuous burst-mode laser, according to various aspects of the present disclosure;

FIG. 2 is a block diagram illustrating an exemplary implementation of the quasi-continuous burst-mode laser of FIG. 1, wherein the exemplary implementation can produce a burst of ten milliseconds, according to various aspects of the present disclosure;

FIG. 3 is a block diagram illustrating a second exemplary implementation of the quasi-continuous burst-mode laser of FIG. 1, wherein the second exemplary implementation is an all-diode-pumped implementation and can produce a burst of thirty milliseconds, according to various aspects of the present disclosure; and

FIG. 4 is a flow chart illustrating a method for creating a high-energy, high-power laser burst, according to various aspects of the present disclosure.

### DETAILED DESCRIPTION

According to aspects of the present disclosure, a burst-mode laser includes a master oscillator, a pulse picker optically coupled to the master oscillator, and a diode-pumped amplifier optically coupled to the pulse picker. The master oscillator generates an oscillator output, which may be pulsed or continuous. The pulse picker modifies the oscillator output to provide a pulsed signal (i.e., train of pulses). These pulses can be spaced, for example, anywhere from ten nanoseconds to tens of milliseconds apart with a pulse width limited only by the space between the pulses and the pulse picker.

The pulsed signal output by the pulse picker feeds the diode-pumped amplifier, which amplifies the pulsed signal. The signal may then leave the laser. However, the signal may, in certain illustrative implementations, pass through additional amplifiers (e.g., diode-pumped, flashlamp, etc.) before leaving the laser. Further, the signal may pass through a wavelength-tuning module, which modifies a wavelength of the signal. Thus, as an example, the diode-pumped amplifier can amplify a pulsed signal from the pulse picker that has a width of 13 nanoseconds, a spacing often microseconds, an energy of ten microjoules per pulse, and a wavelength of 1064 nanometers to burst hundreds of pulses of hundreds of millijoules per pulse.

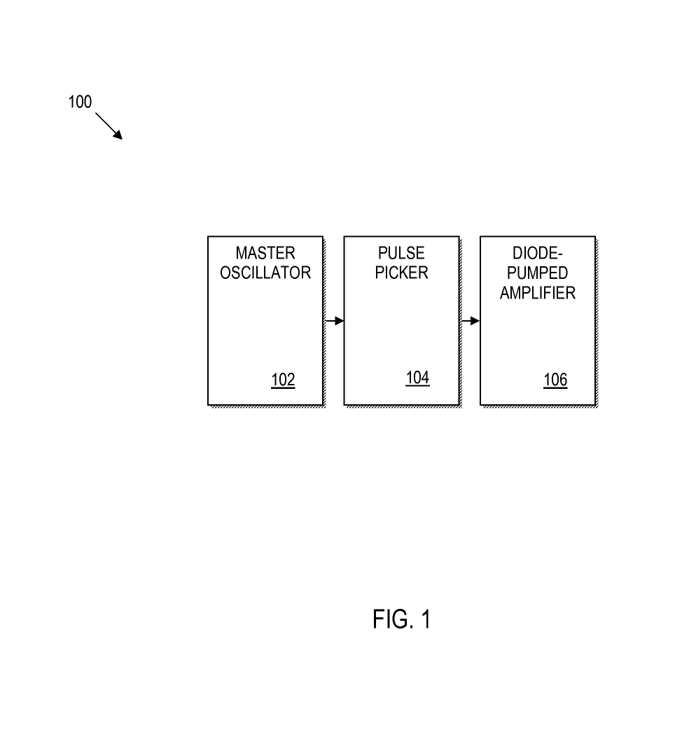

Turning to the figures, and in particular to FIG. 1, a quasi-continuous burst-mode laser 100 includes a master oscillator 102, a pulse picker 104, and a diode-pumped amplifier 106.

The master oscillator 102 generates a signal at a particular wavelength, which feeds the pulse picker 104. For example, the master oscillator 102 may be a fiber laser, which is a laser with an active gain medium of an optical fiber doped with at least one rare-earth element (e.g., erbium, ytterbium, neodymium, dysprosium, praseodymium, and thulium). The utilization of a fiber laser as the master oscillator 102 reduces the initial gain required in the amplifier chain and provides short pulses with high spatial mode quality and low divergence. The master oscillator 102 may alternatively comprise a solid state pulsed laser, a solid state continuous laser, etc. The signal generated by the master oscillator 102 may be a continuous signal or a pulsed signal. Further, the master oscillator 102 may produce a signal of any desired wavelength (e.g., infrared, ultraviolet, color of visible light, etc.). For example, the master oscillator 102 may generate a continuous infrared signal to feed to the pulse picker. As will be described more fully herein, the signal eventually propagates through the burst-mode laser in one form or another (e.g., train of pulses, amplified pulse train, wavelength-tuned signal, etc.).

The pulse picker 104 receives the signal from the master oscillator 102 and creates a train of pulses from the signal. The pulse picker 104 can be implemented as a pulse-conditioning stage, which cuts bursts of pulses out of the pulse train from the master oscillator, controls the pulse time spacing in the bursts, removes background interference from the pulse train, or combinations thereof. More particularly, the pulse picker 104 may incorporate an electro-optical modulator (EOM). In practice, the EOM parameters such as bandwidth and extinction ratio can vary. Moreover, the EOM can be used in a single-pass configuration or double-pass configuration, as well as a tandem of two or more EOMs.

The use of the EOM reduces amplified spontaneous emission and is more flexible compared to conventional phase-conjugate mirrors based on stimulated Brillouin scattering (SBS). Such SBS mirrors utilize liquid as an active medium and due to nonlinear nature of the SBS and requirements for beam focusing have limited operation energy dynamic range. To the contrary, the pulse picker 104 does not require focusing and is based on linear effect and, therefore has no lower level energy limitation and the upper energy is only limited by EOM damage threshold.

For example, the pulse picker 104 may take a continuous signal from the master oscillator 102 and create a train of pulses with the spacing between the pulses being up to 10 milliseconds. As another example, in some applications, the spacing may be as short as 10 microseconds. A more specific example of pulse width includes a pulse picker 104 that takes the continuous signal from the master oscillator 102 and creates a pulse train that has 100 nanoseconds between pulses, with the width of the pulses around 10-13 nanoseconds, and the pulses include 10 microjoules of energy. If the pulse picker 104 receives a pulsed signal from the master oscillator 102, then the pulse picker 104 can alter the signal to create the train of pulses (e.g., remove some of the pulses, reduce the width of the pulses, etc.). In practice, the requirements of the application will dictate the ultimate pulse train configuration.

Thus, the pulse picker 104 controls the repetition rate of the train of pulses. The pulse picker 104 can also reduce amplified spontaneous emission of the train of pulses, which feeds the diode-pumped amplifier 106. In an illustrative implementation, the pulse picker 104 is implemented using a fiber-coupled electro-optic modulator (EOM) configured in a double-pass configuration. However, in practice, the pulse picker 104 may be implemented using other configurations.

The diode-pumped amplifier 106 amplifies the train of pulses to create an amplified pulse train. The use of a diode-pumped amplifier (e.g., Nd:YAG amplifier) achieves relatively high gain at relatively long burst durations, which have an order of magnitude higher efficiency compared to flashlamp pumped amplifiers and are not limited by the explosion energy of the flashlamps. The utilization of the high-gain diode-pumped amplifier 106 allows compact overall system design, and high energy efficiency that facilitates a compact electrical system with reduced number and size of capacitors that store electrical energy.

The diode-pumped amplifier 106 may be a sole amplifier in the system. Alternatively, the diode-pumped amplifier 106 may be part of a larger amplifier chain. Where an amplifier chain is used to cascade (optically couple) gain stages, each of the diode-pumped amplifiers (or other amplifier topologies) can have similar or different properties to achieve desired gain characteristics.

Moreover, the diode-pumped amplifier 106 may include an amplifier rod of any acceptable material such as Nd:YAG, Nd:glass, Nd:YLF, and Nd:YVO₄. For example, the amplifier rod may be a neodymium-doped yttrium aluminum garnet (Nd:YAG) rod or a neodymium-doped glass (Nd:glass) rod. In an amplifier chain, the diode-pumped amplifiers can have different rod diameters. For example, if the diode-pumped amplifier 106 is part of an amplifier chain, then the sizes of the rods of the diode-pumped amplifiers may increase as the signal propagates through the amplifier chain. As an illustration, in an amplifier chain with three diode-pumped amplifiers, the first amplifier in the chain may have a 2-mm-diameter rod, the second amplifier in the chain may also have a 2-mm-diameter rod, and the third amplifier may have a 5-mm-diameter rod. However, a constant or increasing rod-size is not necessarily required.

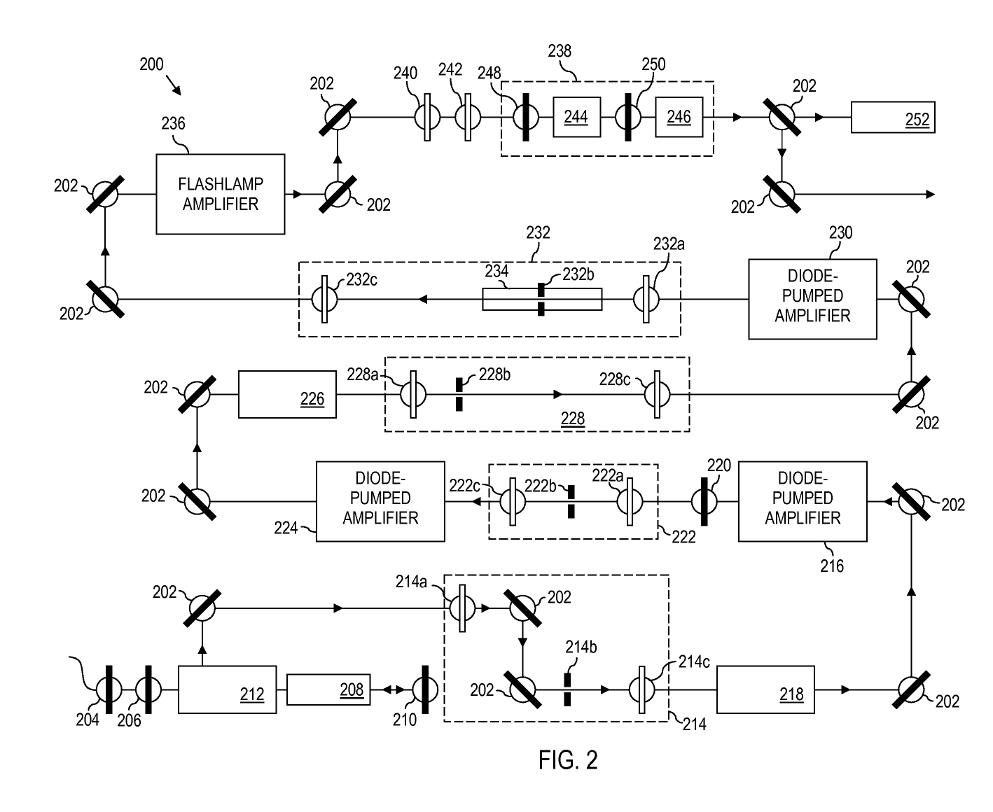

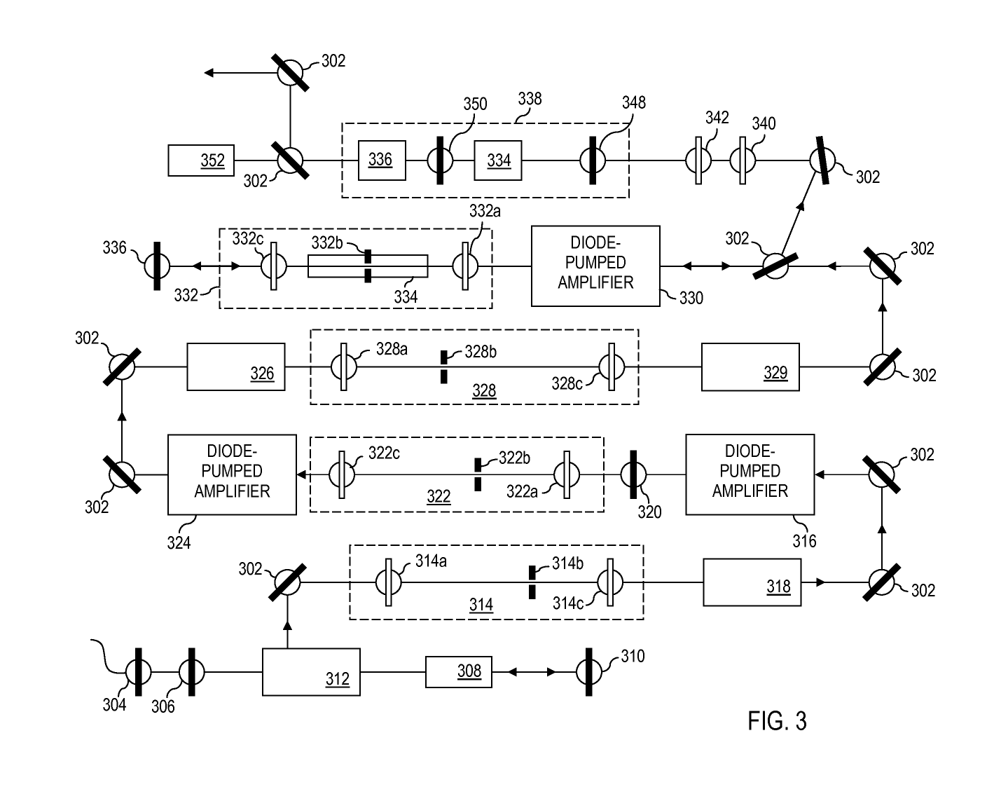

Further examples of using multiple amplifiers are described below in reference to FIGS. 2-3. If the diode-pumped amplifier 106 is part of a larger amplifier chain, the other amplifiers do not necessarily need to be diode-pumped amplifiers (as shown in the exemplary burst-mode laser of FIG. 2) or the amplifier chain can contain all diode-pumped amplifiers (as shown in FIG. 3). Also, the amplifier chain may include spatial filters, optic isolators, or both between the amplifiers. These filters and isolators help reduce amplified spontaneous emission within the signal propagating through the burst-mode laser.

In an exemplary laser with a three-amplifier amplifier chain, the train of pulses output by the pulse picker 104 feeds the first diode-pumped amplifier 106, which amplifies the train of pulses to create a first amplified pulse train. That first amplified pulse train feeds the second diode-pumped amplifier, which amplifies the train of pulses to create a second amplified pulse train. Then, the second amplified pulse train feeds the third diode-pumped amplifier, which amplifies the train of pulses to create a third amplified pulse train.

Once the signal propagates through the amplifier chain (or just the single diode-pumped amplifier 106 if there are no other amplifiers in the system), the signal may leave the laser or the signal may propagate through more components. For example, the amplified train of pulses may feed into a wavelength-tuning module, which alters the wavelength of the amplified pulse train. The wavelength-tuning module generates harmonics of the signal from the master oscillator 102 (e.g., second harmonic, third harmonic, etc.) for output from the burst-mode laser. For example, if the wavelength of the signal from the master oscillator is 1064.3 nanometers (nm), then the wavelength-tuning module may generate a 355 nm wavelength output, and the laser 100 can emit this third-harmonic output for use.

Thus, the master oscillator 102 sets the fundamental wavelength for the laser output. The pulse picker 104 modifies the output of the master oscillator 102 (e.g., by selecting, gating, filtering, chopping, etc.) to define the burst signal in terms of burst length and number of pulses per burst. Within each pulse of the pulse picker 104, there can be a number of cycles of the output of the master oscillator 102 that varies depending upon the selected pulse width. The diode-pumped amplifier 106 (including any additional amplifier stages) provides the necessary gain and other processing to reduce amplified spontaneous emission within the signal propagating through the amplifiers such that the output of the laser has the desired energy for the intended application.

FIGS. 2-3 illustrate exemplary lasers based on the laser of FIG. 1. Turning now to FIG. 2, a quasi-continuous burst-mode laser 200 that can emit a 355-nm wavelength signal with a burst duration around ten milliseconds (ms) and energy of 30 millijoules per pulse is shown. The laser 200 is shown including several reflectors (e.g., mirrors) 202 to allow the laser to fit into a relatively small housing. However, such reflectors 202 are not required for proper operation of the laser; they are included only to give a specific shape to the housing. For example, the exemplary laser 200 can fit into a 3-foot×2-foot (approximately 0.91-meter×0.61-meter) housing.

A master oscillator is provided, which is analogous in function to the master oscillator 102 of FIG. 1. More particularly, the master oscillator includes an ytterbium-doped fiber laser 204 that generates a continuous 100-kilohertz pulsed signal at 1064.3 nm (i.e., fundamental beam) with a line width less than 2 gigahertz. The pulse duration of the fiber laser may be 13 ns for applications involving the study of gas-phase molecular transitions at high temperature. The master oscillator may utilize a polarization-maintaining single-mode fiber that results in a Gaussian beam profile with an M² factor of 1.3.

To form bursts of pulses and to control the pulse train repetition rate, the output of the fiber is collimated and directed into a pulse picker. The pulse picker is analogous in function to the pulse picker 104 of FIG. 1. More particularly, the signal from the master oscillator feeds a half-wave plate 206, is collimated, and feeds a pulse picker. The exemplary pulse picker is a one-megahertz bandwidth free space EOM 208 configured in a double pass configuration. Thus, the signal enters the EOM 208 in a first direction, contacts a reflector 210 perpendicular to the signal, passes back through the EOM 208 in the direction opposite of the first direction, and passes to an optical isolator 212. In this configuration, the pulse picker can achieve an extinction ratio of 2×10³, which completely suppresses amplified spontaneous emission (ASE) from the fiber laser 204. Thus, the pulse picker generates a train of pulses from the signal.

The train of pulses feeds into a first spatial filter 214 before entering a first diode-pumped amplifier 216. The first spatial filter 214 includes a first spherical lens 214a that focuses the train of pulses to a pinhole 214b, and a second spherical lens 214c disperses and collimates the train of pulses at the pinhole 214b to pass onto the first diode-pumped amplifier 216 through a second optical isolator 218. In this example, the focal length of the first lens 214a is 150 mm and the focal length of the second lens 214c is 100 mm. The first spatial filter 214 helps to reduce amplified spontaneous emission further.

The first diode pumped-amplifier 216 is analogous in function to the diode-pumped amplifier 106 of FIG. 1. In a particular exemplary implementation, first diode-pumped amplifier 216 is a 2-mm-diameter Nd:YAG-rod diode-pumped amplifier and amplifies the train of pulses from the pulse picker to create a first amplified pulse train. In the exemplary laser 200, the first diode-pumped amplifier 216 feeds a quartz rotator 220 before feeding a second spatial filter 222. The quartz rotator 220 compensates for thermally induced birefringence, and the second spatial filter 222 further reduces the amplified spontaneous emission. The second spatial filter 222 is configured similarly to the first spatial filter 214. Thus, the second spatial filter 222 has a first spherical lens 222a that focuses the train of pulses to a pinhole 222b and a second spherical lens 222c that disperses and collimates the train of pulses at the pinhole 222b. In this example, the focal length of both the first lens 222a and the second lens 222c is 75 mm.

The first amplified pulse train eventually feeds into a second diode-pumped amplifier 224 which amplifies the first amplified pulse train to create a second amplified pulse train. As with the first diode-pumped amplifier 216, the exemplary second diode-pumped amplifier 224 is a 2-mm-diameter Nd:YAG-rod diode-pumped amplifier. The second amplified pulse train passes through a third optical isolator 226 and a third spatial filter 228, which is similar to the first spatial filter 214. Thus, the third spatial filter 228 has a first spherical lens 228a that focuses the train of pulses to a pinhole 228b, and a second spherical lens 228c that disperses and collimates the train of pulses at the pinhole 222b. In this example, the focal length of the first lens 222a is 75 mm and the focal length of the second lens 228c is 250 mm. Again, the spatial filters and optical isolators prevent feedback and reduce the amplified spontaneous emissions in the pulse train.

The second amplified pulse train eventually feeds into a third diode-pumped amplifier 230 in the amplifier chain, and the third diode-pumped amplifier 230 is a 5-mm-diameter Nd:YAG-rod diode-pumped amplifier and amplifies the second amplified pulse train to create a third amplified pulse train. The third amplified pulse train passes through a fourth spatial filter 232 (similar to the first spatial filter 214). Thus, the fourth spatial filter 232 has a first spherical lens 232a that focuses the train of pulses to a pinhole 232b and a second spherical lens 232c that disperses and collimates the train of pulses at the pinhole 222b. In this example, the focal length of the first lens 232a is 125 mm and the focal length of the second lens 232c is 200 mm. However, the exemplary fourth spatial 232 further includes a vacuum cell 234 to prevent air ionization as the first lens 232a focuses the third amplified pulse train to the pinhole 232b.

After passing through the fourth spatial filter 232, the third amplified pulse train enters a fourth amplifier 236. This exemplary amplifier 236 is considerably different than the first, second, and third amplifiers 216, 224, 230 because the fourth amplifier 236 is not a diode-pumped amplifier. Instead, the fourth amplifier 236 is a low-gain, high-power, Nd:YAG 9.5-mm rod diameter flashlamp amplifier. This flashlamp amplifier 236 amplifies the third amplified pulse train further, effectively achieving a two-fold energy gain before passing the amplified pulse train to a wavelength-tuning module 238 through two lenses 240, 242 with focal lengths of −100 mm and 150 mm respectively.

The diode-pumped amplifiers 216, 224, 230 and flash lamp amplifier 236 may be fired at a 0.5-hertz repetition-rate to allow for the Nd:YAG rods to thermally relax (i.e., cool).

The exemplary wavelength-tuning module 238 includes a potassium titanyl phosphate type-two (KTP type II) crystal 244 and a lithium triborate type-one (LBO type I) crystal 426. The KTP-type-II crystal 244 doubles the third amplified pulse train, and the LBO-type-I crystal 246 effectively triples the third amplified pulse train, resulting in a 355-nm-wavelength (i.e., ultraviolet) signal out of the laser 200. Further, a half-wave plate 248 is included before the KTP-type-II crystal 244, and a dual-wavelength wave plate 250 is included between the KTP-type-II crystal 244 and the LBO-type-I crystal 246. These wave plates 248, 250 control the fundamental-beam polarization, which allows the laser 200 to emit only the 355-nm-wavelength signal, while the fundamental wavelength is dumped by a beam dump 252.

The exemplary laser 200 can produce a quasi-continuous beam at 355-nm for 10 ms. The amplifier bars can produce a flat gain for up to 50 ms at low currents (e.g., 40-60 amperes (A)). However, at high currents (e.g., 80 A), the flat gain of the amplifier bars is restricted to about 10-20 ms. However, the flashlamp amplifier 236 has a flat gain of only about ten ms. Therefore, at high currents, the exemplary laser 200 may be operated for example, at a burst of 10 ms with hundreds of pulses per burst and energy of 150 millijoules per pulse at 1064 nm.

Due to utilization of the fiber master oscillator and highly efficient, high-gain diode-pumped amplifiers, the laser 200 may be implemented so as to achieve low electrical power consumption of about 1 kW, which is similar to the power consumption of a standard high pulse energy, 10 Hz Nd:YAG laser.

Turning now to FIG. 3, a second exemplary laser 300, similar to the laser of FIG. 2 is shown. However, this laser 300 does not include the flashlamp amplifier stage (among other things) of the laser of FIG. 2. That is, the laser 300 is an all-diode pumped laser source. The laser 300 is shown including several reflectors 302 (e.g., mirrors) to allow the laser to fit into a relatively small housing. However, such reflectors 302 are not required for proper operation of the laser, they are included only to give a specific shape to the housing. For example, the exemplary laser 300 can fit into a housing less than a meter squared.

The laser 300 includes a master oscillator analogous in function to the master oscillator 102 of FIG. 1. In a particular example, the master oscillator is an ytterbium-doped fiber laser that generates a continuous 100-kilohertz pulsed signal at 1064.3 nm (i.e., fundamental beam) with 10 μJ per pulse. Each pulse in the signal is about 13 ns, and the line width is less than 2 gigahertz. In another example, the fiber laser may generate any frequency between 100 kHz and 1 MHz.

The signal feeds a half-wave plate 306, is collimated, and feeds a pulse picker that is analogous in function to the pulse picker 104 of FIG. 1. The exemplary pulse picker is a one-megahertz bandwidth fiber-coupled EOM 308 configured in a double pass configuration. Thus, the signal enters the EOM 308 in a first direction, contacts a reflector 310 perpendicular to the train of pulses, passes back through the EOM 308 in the direction opposite of the first direction, and passes to an optical isolator 312. In this configuration, the pulse picker can achieve an extinction ratio of 2*10³, which completely suppresses amplified spontaneous emission from the fiber laser. Thus, the pulse picker emits a train of pulses.

The pulse picker feeds a first spatial filter 314 before entering a first diode-pumped amplifier 316. The first spatial filter 314 includes a first spherical lens 314a that focuses the train of pulses to a pinhole 314b, and a second spherical lens 314c collimates the train of pulses dispersed from the pinhole 314b to pass onto the first diode-pumped amplifier 316 through a second optical isolator 318. In this example, the focal length of the first lens 314a is 150 mm and the focal length of the second lens 314c is 100 mm. The first spatial filter 314 helps to reduce amplified spontaneous emission further.

The exemplary first diode-pumped amplifier 314 is a 2-mm-diameter Nd:YAG-rod diode-pumped amplifier and amplifies the train of pulses to create a first amplified pulse train. In the exemplary laser 300, the first diode-pumped amplifier 316 feeds a quartz rotator 320 before feeding a second spatial filter 322. The quartz rotator 320 compensates for thermally induced birefringence, and the second spatial filter 322 further reduces the amplified spontaneous emission. The second spatial filter 322 is configured similarly to the first spatial filter 314. Thus, the second spatial filter 322 has a first spherical lens 322a that focuses the train of pulses to a pinhole 322b and a second spherical lens 322c that collimates the train of pulses dispersed from the pinhole 322b. In this example, the focal length of both the first lens 322a and the second lens 322c is 75 mm.

The first amplified pulse train eventually feeds a second diode-pumped amplifier 324 which amplifies the first amplified pulse train to create a second amplified pulse train. As with the first diode-pumped amplifier 324, the exemplary second diode-pumped amplifier 324 is a 2-mm-diameter Nd:YAG-rod diode-pumped amplifier. The second amplified pulse train passes through a third optical isolator 326 and a third spatial filter 328. The third spatial filter 328 is similar to the first spatial filter 314. Thus, the third spatial filter 328 has a first spherical lens 328a that focuses the train of pulses to a pinhole 328b and a second spherical lens 328c that collimates the train of pulses dispersed from the pinhole 328b. In this example, the focal length of the first lens 328a is 75 mm and the focal length of the second lens 328c is 250 mm. Again, the spatial filters and optical isolators reduce the amplified spontaneous emissions in the pulse train. The third spatial filter 328 feeds a fourth optical isolator 329. The total gain of these first two amplifiers reaches approximately three orders of magnitude with output-pulse energy of 4 millijoules.

The second amplified pulse train feeds a third diode-pumped amplifier 330 and a fourth spatial 332 filter that is set up in a double-pass configuration, similar to the EOM 308 of the pulse picker 104. The third diode-pumped amplifier 330 in the amplifier chain is a 5-mm-diameter Nd:YAG-rod diode-pumped amplifier. Similar to the pulse picker, the second amplified pulse train passes through the third diode-pumped amplifier 330 in a first direction, contacts a reflector 336 perpendicular to the second amplified pulse train, and passes through the third diode-pumped amplifier 330 again in the direction opposite of the first direction. Further, the fourth spatial filter 332 is placed between the third diode-pumped amplifier 330 and the reflector 336. The fourth spatial filter 332 includes a first spherical lens 332a that focuses the train of pulses to a pinhole 332b and a second spherical lens 332c that collimates the train of pulses dispersed from the pinhole 332b. The fourth spatial filter 332 also includes a vacuum cell 334 to prevent air ionization as the lenses 332a, 332c focus the pulse train to the pinhole 332b. The focal length of the first lens 332a is 125 mm, and the focal length of the second lens 332c is 125 mm (different than the laser of FIG. 2). The third amplified pulse train feeds a wavelength-tuning module 338 through two spherical lenses 340, 342 with focal lengths of −100 mm and 150 mm, respectively.

In an illustrative implementation, the diode-pumped amplifiers 316, 324, 330 are fired at a 0.25-hertz repetition-rate to allow for the Nd:YAG rods to thermally relax (i.e., cool).

The exemplary waveform-tuning module 338 of the second exemplary laser 300 includes two temperature-controlled LBO-type-I crystals 334, 336. An oven (not shown) keeps the first crystal 334, which doubles the third amplified pulse train, at a temperature of 149.7° C. and the second crystal 336, which effectively triples the third amplified pulse train, at 60° C. Further, a half-wave plate 348 is included before the first crystal 334, and a dual-wavelength wave plate 350 is included between the first crystal 334 and the second crystal 336. These wave plates 348, 350 control the fundamental-beam polarization, which allows the laser 300 to emit only the 355-nm-wavelength (i.e., ultraviolet) signal, while the fundamental wavelength is dumped by a beam dump 352.

Further, the laser 300 includes a liquid cooling system that helps regulate the temperature of the diode rods. It was found that maintaining a temperature of approximately 29° C. helps improve the flat-gain regions of the diode rods at higher currents in this exemplary laser 300. Thus, the liquid cooling system regulates the temperature of the diode rods to approximately 29° C.

The diode-pumped amplifiers include a flat gain range of about 20-50 ms depending on the current. Thus, at high current, the exemplary laser 300 is capable of emitting a 30-ms burst of over a thousand of pulses with over a hundred millijoules per pulse, resulting in energy on the order of joules per burst.

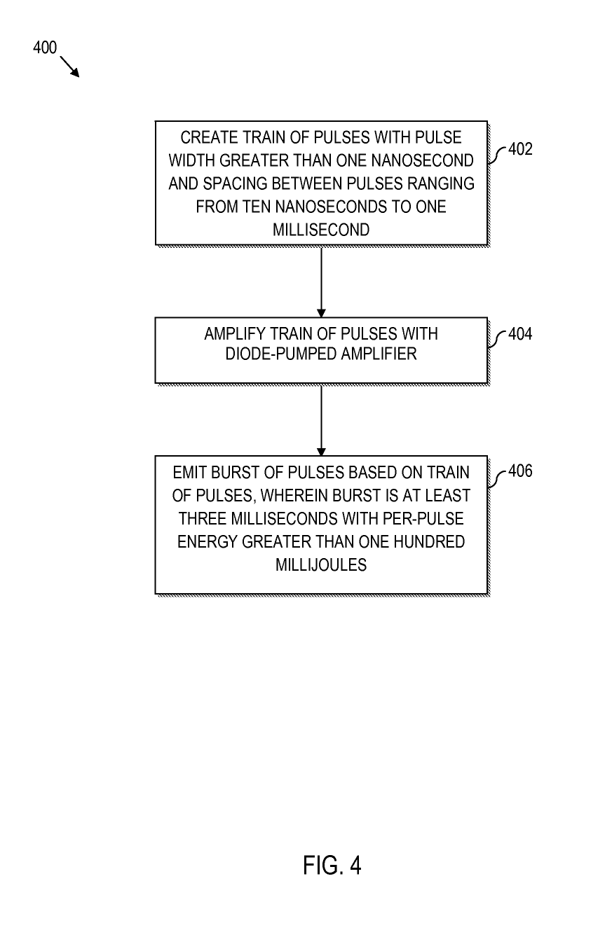

Turning to FIG. 4, a method 400 for creating a high-energy, high-power burst of pulses is disclosed. At 402, a train of pulses with a pulse width greater than one nanosecond and a spacing between the pulses ranging between ten nanoseconds and one millisecond is created. For example, the train of pulses may be created by a master oscillator (e.g., fiber laser) creating a continuous or pulsed signal that feeds into a pulse picker (e.g., EOM) to create the train of pulses.

At 404, the train of pulses is amplified by a diode-pumped amplifier. The train of pulses may be further amplified by one or more diode-pumped amplifiers, one or more flashlamp amplifiers, or a combination thereof. Moreover, the wavelength of the train of pulses may be tuned by a wavelength-tuning module to create other wavelengths (e.g., second harmonic, third harmonic, etc.); for example, an infrared signal may be tuned to become a visible light signal, an ultraviolet signal, etc.

At 406, the train of pulses is emitted as a burst of pulses for at least three milliseconds, with per-pulse energy of over 100 millijoules.

According to illustrative aspects of the present disclosure, a compact high-repetition-rate high-pulse-energy nanosecond laser source is provided, that provides long pulse train duration and a narrow spectral bandwidth. As such, the laser sources described herein are suitable for high-resolution spectroscopy and planar imaging of reactive intermediates, including monitoring low-frequency instabilities and high-speed reacting fluid dynamics. As another illustrative example, the laser sources herein can have a pulse train configured to scale around the dynamics of a reacting flow being evaluated, even where the time dynamics of that flow require a pulse train of 10 ms or longer.

For instance, with the devices and methods of the present disclosure, a train of pulses with pulse widths on the order of nanoseconds and a spacing between pulses of any desired spacing (e.g., 10 microseconds or less, up to 10 milliseconds, etc.) may be amplified to create a burst of pulses greater than three milliseconds with a per-pulse energy over 100 millijoules. Thus, the devices and methods of the present disclosure can be used in a variety of applications including high-speed measurements of temperature, mixture fraction, PLIF of OH, NO, CH, and CH₂O, and Raman line imaging of O₂, N₂, CH₄, and H₂, with measurements ranging from 1 kHz to 1 MHz.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A burst-mode laser comprising:
a master oscillator, which generates a signal;
a pulse picker optically coupled to the master oscillator, wherein the pulse picker creates a train of pulses from the signal, wherein the spacing between the pulses of the train of pulses ranges from ten nanoseconds to one millisecond; and
a first diode-pumped amplifier optically coupled to the pulse-picker, wherein the first diode-pumped amplifier amplifies the train of pulses to create a first amplified pulse train.

2. The burst-mode laser of claim 1, wherein the master oscillator generates a continuous signal.

3. The burst-mode laser of claim 1, wherein the master oscillator generates a pulsed signal.

4. The burst-mode laser of claim 1, wherein the master oscillator includes a fiber laser.

5. The burst-mode laser of claim 1, wherein:
the signal generated by the master oscillator includes a wavelength; and
the burst-mode laser further includes a wavelength-tuning module that receives the first amplified pulse train and alters the wavelength of the first amplified pulse train.

6. The burst-mode laser of claim 1, wherein the pulse picker generates a pulse of the train of pulses that is 13 nanoseconds wide and has 10 microjoules of energy.

7. The burst-mode laser of claim 1, wherein the pulse picker includes a fiber-coupled electro-optic modulator.

8. The burst-mode laser of claim 7, wherein the electro-optic modulator includes an optic isolator and is configured in a double-pass configuration such that the signal:
passes through the electro-optic modulator in a first direction,
contacts a reflector perpendicular to the train of pulses, and
passes through the electro-optic modulator again in the direction opposite of the first direction.

9. The burst-mode laser of claim 1, wherein the pulse picker includes a free space electro-optic modulator.

10. The burst-mode laser of claim 1, wherein the first diode-pumped amplifier includes a neodymium-doped yttrium aluminum garnet rod.

11. The burst-mode laser of claim 1, wherein the first diode-pumped amplifier includes a neodymium-doped glass rod.

12. The burst-mode laser of claim 1 further including a first spatial filter optically coupled between the pulse picker and the first diode-pumped amplifier.

13. The burst-mode laser of claim 1 further comprising:
a second diode-pumped amplifier optically coupled to the first diode-pumped amplifier, wherein the second diode-pumped amplifier amplifies the first amplified pulse train to create a second amplified pulse train; and
a third diode-pumped amplifier optically coupled to the second diode-pumped amplifier, wherein the third diode-pumped amplifier amplifies the second amplified pulse train to create a third amplified pulse train.

14. The burst-mode laser of claim 13 wherein:
the first diode-pumped amplifier includes a neodymium-doped yttrium aluminum garnet rod that is 2 millimeters in diameter;
the second diode-pumped amplifier includes a neodymium-doped yttrium aluminum garnet rod that is 2 millimeters in diameter; and
the third diode-pumped amplifier includes a neodymium-doped yttrium aluminum garnet rod that is 5 millimeters in diameter.

15. The burst-mode laser of claim 13, wherein the third diode-pumped amplifier is configured in a double-pass configuration such that the second amplified pulse train:
passes through the third diode-pumped amplifier in a first direction,
contacts a reflector perpendicular to the second amplified pulse train, and
passes through the third diode-pumped amplifier again in the direction opposite of the first direction.

16. The burst-mode laser of claim 15 further including a vacuum cell optically coupled between the third diode-pumped amplifier and the mirror.

17. The burst-mode laser of claim 13 further including a flashlamp amplifier optically coupled to the third diode-pumped amplifier.

18. The burst-mode laser of claim 13 further including a vacuum cell optically coupled between the third diode-pumped amplifier and the flashlamp amplifier.

19. The burst-mode laser of claim 13 further including:
a first spatial filter optically coupled between the pulse picker and the first diode-pumped amplifier;
a second spatial filter optically coupled between the first diode-pumped amplifier and the second diode-pumped amplifier; and
a third spatial filter optically coupled between the second diode-pumped amplifier and the third diode-pumped amplifier.

20. The burst-mode laser of claim 1 further including a quartz rotator coupled between the first diode-pumped amplifier and the second diode-pumped amplifier.

21. A device comprising:
a fiber laser, which generates a signal;
an electro-optical modulator optically coupled to the fiber laser, wherein:
the electro-optical modulator creates a train of pulses from the signal, wherein the spacing between the pulses of the train of pulses ranges from ten nanoseconds to one millisecond; and
the electro-optical modulator is configured in a double-pass configuration such that the signal:
passes through the electro-optic modulator in a first direction,
contacts a reflector perpendicular to the signal, and
passes through the electro-optic modulator again in the direction opposite of the first direction;
a first spatial filter optically coupled to the electro-optical modulator;
a first diode-pumped amplifier optically coupled to the first spatial filter, the first diode-pumped amplifier including a neodymium-doped yttrium aluminum garnet rod that is 2 millimeters in diameter, wherein the first diode-pumped amplifier amplifies the train of pulses to create a first amplified pulse train;
a quartz rotator optically coupled to the first diode-pumped amplifier
a second spatial filter optically coupled to the quartz rotator;
a second diode-pumped amplifier optically coupled to the second spatial filter, the first diode-pumped amplifier including a neodymium-doped yttrium aluminum garnet rod that is 2 millimeters in diameter, wherein the second diode-pumped amplifier amplifies the first amplified pulse train to create a second amplified pulse train;
a third spatial filter optically coupled to the second diode-pumped amplifier;
an optical isolator optically coupled to the third spatial filter;
a third diode-pumped amplifier optically coupled to the optical isolator, the third diode-pumped amplifier including a neodymium-doped yttrium aluminum garnet rod that is 5 millimeters in diameter, wherein:
the third diode-pumped amplifier is configured in a double-pass configuration such that the second amplified pulse train:
passes through the electro-optic modulator in a first direction,
passes through a vacuum cell;
contacts a reflector perpendicular to the second amplified pulse train,
passes through the vacuum cell again in the direction opposite of the first direction, and
passes through the electro-optic modulator again in the direction opposite of the first direction; and
the third diode-pumped amplifier amplifies the second amplified pulse train to create a third amplified pulse train;
a fourth third spatial filter optically coupled to the third diode-pumped amplifier.

22. A method comprising:
creating a train of pulses including pulses with a pulse width greater than one nanosecond and a spacing between the pulses of the train of pulses ranging from ten nanoseconds to one millisecond;
using a diode-pumped amplifier to amplify the train of pulses; and
emitting a burst of pulses for at least 3 milliseconds, wherein the burst of pulses is based on the train of pulses and the pulses in the burst of pulses include an average of at least 100 millijoules per pulse.
